(19) United States
(12) Patent Application Publication
(10) Pub. No.: US 2023/0150385 A1
(43) Pub. Date: May 18, 2023

(54) METHOD OF CONDITIONING BATTERY OF ELECTRIC VEHICLE

(71) Applicants: Hyundai Motor Company, Seoul (KR); Kia Corporation, Seoul (KR)

(72) Inventors: Seung Myun CHUNG, Seoul (KR); Dae Gun JIN, Suwon-Si (KR); Gwang Su PARK, Seongnam-Si (KR); Jin Gyu LIM, Gumi-Si (KR); Tae Geun JEONG, Seoul (KR); Joong Woo LEE, Yongin-Si (KR)

(73) Assignees: Hyundai Motor Company, Seoul (KR); Kia Corporation, Seoul (KR)

(21) Appl. No.: 17/983,056

(22) Filed: Nov. 8, 2022

(30) Foreign Application Priority Data
Nov. 17, 2021 (KR) 10-2021-0158205

(51) Int. Cl. B60L 53/62; G07C 5/08; B60L 58/12; B60L 58/27; G01C 21/34; H01M 10/44; H01M 10/48; H01M 10/625; H01M 10/63; H01M 10/615

(52) U.S. Cl. CPC B60L 53/62; G07C 5/0825; B60L 58/12; B60L 58/27; G01C 21/3476; H01M 10/443; H01M 10/486; H01M 10/625; H01M 10/63; H01M 10/615; B60L 2240/545; H01M 2220/20

(57) ABSTRACT

A method of conditioning a battery of an electric vehicle, includes obtaining information on a charging time varying with a battery temperature with respect to a battery through testing, and providing, to a controller, charging performance setting information that results from setting by categorizing battery charging performance into a plurality of levels based on the obtained information on the charging time varying with the battery temperature; determining, by the controller, a charging time corresponding to a current battery temperature measured through a sensor, from the measured current battery temperature using the information on the charging time varying with the battery temperature; selecting, by the controller, a level indicating current battery charging performance from the determined charging time corresponding to the current battery temperature using the charging performance setting information; and displaying, by the controller, the selected level on a display device of a vehicle.

### CROSS-REFERENCE TO RELATED APPLICATION

The present application claims priority to Korean Patent Application No. 10-2021-0158205 filed on Nov. 17, 2021, the entire contents of which is incorporated herein for all purposes by this reference.

### BACKGROUND OF THE PRESENT DISCLOSURE

### Field of the Present Disclosure

The present disclosure relates to a method of conditioning a battery of an electric vehicle. More particularly, the present disclosure relates to a method of conditioning a battery of an electric vehicle, the method being capable of providing battery state information associated with a battery charging function in an electric vehicle. With the method, before battery charging, a driver is recommended to control and manage a battery temperature to reach an optimal temperature, and thus, the battery charging performance may be secured.

### Description of Related art

In recent years, with increasing concern about energy efficiency and problems, such as environmental pollution and depletion of fossil fuels, environmentally friendly vehicles (xEV) capable of substantially replacing internal combustion-engine vehicles have been actively under development.

The environmentally friendly vehicles include a battery electric vehicle (BEV) using a battery as a source of motive power (a source of electric power), a fuel cell electric vehicle (FCEV) using a fuel cell as a primary source of motive power, a hybrid electric vehicle (HEV) using both an engine and a motor as driving sources for driving a vehicle, and the like.

The environmentally friendly vehicles have in common that they travel by driving a motor with electric power stored in a battery and may be referred to as electric vehicles in a broad sense. A high-voltage battery supplying electric power to a motor is mounted in the electric vehicle. The high-voltage battery supplies electric power to power electronic components within a vehicle, such as the motor, repeating charging and discharging during vehicle's driving.

The electric vehicle is provided with a battery management system (BMS) comprehensively managing an overall state of the battery. The battery management system collects battery state information and performs control for battery charging and discharging based on the collected battery state information.

Furthermore, the battery management system monitors the battery for a state thereof and thus notifies a higher-level controller of information on a value for limiting charging and discharging current according to a battery temperature, an ambient temperature, a charging state, and the like. Thus, under an optimal condition, the vehicle can travel while performing battery charging and discharging.

The battery mounted in the electric vehicle, when charged, increases in temperature due to a chemical reaction thereinside. This increase in temperature causes a decrease in a charging capacity with respect to a rated capacity of the battery.

When the battery is charged at an unsuitable temperature, that is, when the battery is charged in a state where a temperature thereof is too high or low, charging performance (a charging speed or the like) is remarkably reduced.

Therefore, for the electric vehicle to secure suitable charging performance regardless of the season, there is a demand for control of battery conditioning that maintains and manages the battery temperature to fall within a predetermined range before charging the battery.

Furthermore, when the battery is charged, it is very important to maintain an optimal temperature or control a battery temperature to a temperature at which high-output charging is possible, so that a battery state is recognized and that the battery is charged as much as a maximum capacity of the battery.

To control the battery temperature of the electric vehicle, there is a need to operate a battery heater or operate a cooling system, such a battery chiller, by utilizing energy stored in the battery. However, the vehicle in the related art does not provide the battery state information with respect to the charging performance. Thus, there is a problem in that efficient battery temperature control is difficult to perform.

To secure battery fast-charging performance in the electric vehicle, there is a need to encourage a driver to control the battery temperature to an optimal temperature by providing the battery state information associated with the charging performance to the driver. Moreover, there is a demand for a battery temperature control technology and a technology for providing a path to a charging station that are necessary to secure the charging performance considering the battery state and a path for the vehicle to travel.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a method of conditioning a battery of an electric vehicle, the method being configured for providing battery state information associated with a battery charging function in an electric vehicle. With the method, before battery charging, a driver is recommended to control and manage a battery temperature to reach an optimal temperature, and thus, the battery charging performance may be secured.

Another object of the present disclosure is to provide a method of efficiently controlling a battery temperature and a method of selecting a destination in conjunction with a Global Positioning System (GPS) and proposing a path to a stop (a charging station). In these methods, a path for traveling to a destination is considered.

The present disclosure is not limited to the above-mentioned objects from the following description, other objects of the present disclosure may be clearly understood by a person of ordinary skill in the art to which the present disclosure pertains.

To accomplish the above-mentioned objects, according to an aspect of the present disclosure, there is provided a method of conditioning a battery of an electric vehicle, the method including: obtaining information on a charging time varying with a battery temperature with respect to a battery through testing, and providing, to a controller, charging performance setting information that results from setting by categorizing battery charging performance into a plurality of levels based on the obtained information on the charging time varying with the battery temperature; determining, by the controller, a charging time corresponding to a current battery temperature measured through a sensor, from the measured current battery temperature using the information on the charging time varying with the battery temperature; selecting, by the controller, a level indicating current battery charging performance, among the plurality of levels, from the determined charging time corresponding to the current battery temperature using the charging performance setting information; and displaying, by the controller, the selected level on a display device of the vehicle in an identifiable manner.

Accordingly, with the method of conditioning a battery according to an exemplary embodiment of the present disclosure, while traveling to a destination or a charging station, an electric vehicle operates a battery heater or a battery cooling system using electrical energy stored in the battery. Thus, before charging, a battery temperature may be controlled to reach an optimal temperature. Moreover, the vehicle is provided with battery state information with respect to charging performance. Thus, a driver may be encouraged to experience a learning effect and to secure the charging performance before fast charging.

Furthermore, in the vehicle, a boost mode for increasing battery temperature or a basic mode for increasing the battery temperature is automatically selected and performed considering a battery state and a path for traveling before traveling. Thus, the vehicle can secure the battery state which is at the excellent level in terms of charging performance when arriving at the destination. One of the boost mode for increasing the battery temperature and the basic mode for increasing the battery temperature is selected considering a current battery state, the destination, a current vehicle location, and the like when increasing the battery temperature. Thus, the efficiency of energy management may be increased.

Furthermore, when the destination is set in a navigation device, the vehicle automatically guides the driver in traveling to an optimal fast-charging station which is determined considering the battery state and the path for traveling, as the stop. Thus, efficient battery charging performance may be secured.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a graph illustrating setting information associated with battery charging performance according to an exemplary embodiment of the present disclosure;

FIG. 2 is a diagram illustrating an example of battery state information displayed by a controller on a display device of a vehicle according to an exemplary embodiment of the present disclosure;

FIG. 3 is a flowchart illustrating a battery conditioning process according to the exemplary embodiment of the present disclosure; and

FIG. 4 is a flowchart illustrating a process of proposing a charging station, as a stop, in a method of conditioning a battery according to the exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

An exemplary embodiment of the present disclosure will be described below only in an exemplary manner in terms of specific structures and functions. The exemplary embodiment of the present disclosure may be practiced in various forms without departing from the nature and gist of the present disclosure. The present disclosure may not be construed as being limited to the exemplary embodiment described in the present specification. All alterations, equivalents, and substitutes that are included within the technical idea of the present disclosure should be understood as falling within the scope of the present disclosure.

In the present specification, the terms first, second, and the like are used to describe various constituent elements, but do not impose any limitation on meanings of these constituent elements. These terms are only used to distinguish one constituent element from another. For example, a first constituent element may be termed a second constituent element without departing from the scope of each claim that defines the present disclosure. Likewise, the second constituent element may also be termed the first constituent element.

It should be understood that a constituent element, when referred to as being “coupled to” or “connected to” a different constituent element, may be directly coupled to or directly connected to the different constituent element or may be coupled to or connected to the different constituent element with an intervening constituent element being interposed therebetween. In contrast, it should be understood that a constituent element, when referred to as being “directly coupled to” or “directly connected to” a different constituent element, is coupled to or connected to the different constituent without any intervening constituent element being interposed therebetween. Expressions such as “between” and “directly between” and expressions “adjacent to” and “directly adjacent to” that are used for describing a relationship between constituent elements should be construed in a same manner.

Like reference numerals depict like constituent elements throughout the present specification. The terms used throughout the present specification serve the purpose of describing an exemplary embodiment of the present disclosure, but do not impose any limitation on the present disclosure. Unless specified otherwise throughout the present specification, a singular noun or a singular noun phrase may have a plural meaning. The terms “comprise” and/or “comprising” are intended to indicate that named constituent elements, steps, operations, and/or elements are present, without precluding the presence or addition of one or more other constituent elements, steps, operations, and/or elements.

According to an exemplary embodiment of the present disclosure, there is provided a method of conditioning a battery, the method being configured for providing battery state information associated with battery charging performance of a vehicle. With the present method, before battery charging, a driver is recommended to control and manage a battery temperature to reach an optimal temperature, and thus, the battery charging performance may be secured. Furthermore, according to an exemplary embodiment of the present disclosure, there are provided a method of efficiently controlling a battery temperature and a method of selecting a destination in conjunction with a Global Positioning System (GPS) and proposing a path to a stop (a charging station). In these methods, a path for traveling to a destination is considered.

An exemplary embodiment of the present disclosure will be described in detail below with reference to the accompanying drawing.

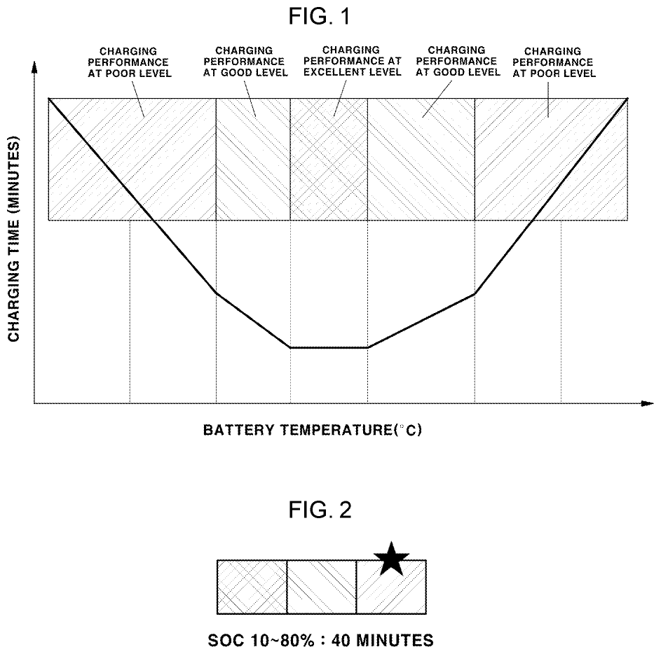

When fast charging a battery of an electric vehicle, an initial battery charging temperature has a great effect on a charging speed and a charging time. The battery charging performance, as illustrated in FIG. 1, may be categorized as being excellent, good, and poor states according to the initial battery charging temperature. At the present point, the initial battery charging temperature may be a temperature that the battery has when battery charging starts. Alternatively, the initial battery charging temperature may be an actual temperature that the battery has at a point in time at which the battery charging performance is determined.

Furthermore, the battery charging performance according to an exemplary embodiment of the present disclosure is performance associated with the battery charging, for example, with a battery charging speed or a battery charging time. In the instant case, that the charging performance is at the excellent level means that the battery charging speed is high and that a charging time is short, and that the charging performance is at the poor level means that the battery charging speed is too low and that the charging time is excessively long. In addition, that the charging performance is at the good level means that the battery charging speed or the battery charging time is neither at the excellent level, nor at the poor level.

Therefore, assuming that the battery is charged at an arbitrary point in time at which the battery charging performance is determined, a controller may be configured so that whether the current battery state is at the excellent, good, or poor level in terms of the charging performance associated with the charging time or the charging speed is determined from information on current battery temperature measured by a sensor using charging performance setting information illustrated in FIG. 1.

The controller may be a battery controller collecting the battery state information, such as a battery temperature and a state of charge (SOC), that is, a battery management system (BMS). Furthermore, the charging performance setting information is information which is used in a state of being in advance input into and stored in the controller. Temperature-varying charging time information of the battery having the same specification is obtained through prior testing and evaluation. In the instant case, the charging performance setting information may be information that results from setting by categorizing the battery charging performance as being at the excellent, good, and poor levels from the obtained charging time information.

With reference to charging performance information illustrated in FIG. 1, the charging performance information is categorized as being at the excellent level when the charging time is shorter than a first setting time. The charging performance information is categorized as being at the good level when the charging time is equal to or longer than the first setting time and is shorter than a second setting time. The charging performance information is categorized as being at the poor level when the charging time is equal to or longer than the second setting time. At the present point, the second setting time is set to have a higher value than the first setting time, that is, to be longer than the first setting time.

For example, the first setting time may be set to 20 minutes, and the second setting time may be set to 30 minutes. That is, when the charging time is less than 20 minutes, the charging performance information may be categorized as being at the excellent level. Moreover, when the charging time is equal to or longer than 20 minutes and less than 30 minutes, the charging performance information may be categorized as being at the good level. Moreover, when the charging time is equal to or longer than 30 minutes, the charging performance information may be categorized as being at the poor level. Of course, the first setting time of 20 minutes and the second setting time of 30 minutes are exemplary. Therefore, the present disclosure is not limited thereto. The first setting time and the second setting time may be set so that varies with battery specifications or battery features.

In FIG. 1, the charging time information of the battery that varies with the battery temperature (the initial charging temperature) is plotted on a graph. From FIG. 1, it may be seen that, using a plot of the charging time versus the battery temperature, the battery charging performance are categorized and set as three levels: excellent, good, and poor. The controller may be configured to determine the charging time from the current battery temperature before and during vehicle traveling, using the charging time information plotted on a graph in FIG. 1. Accordingly, the controller may be configured to determine current charging performance as being at the excellent, good, or poor level from the determined charting time using the charging performance information.

Furthermore, on the graph in FIG. 1, the battery charging time that varies with the battery temperature may be defined as the time taken to fast charge the battery according to a charging condition determined to cause at the corresponding battery temperature a change from a preset first SOC value to a second SOC value. At the present point, As an exemplary embodiment of the present disclosure, the first SOC value and the second SOC value may be set to 10% and 80%, respectively. The first SOC value and the second SOC value may be changed. For example, the first SOC value may be 0% instead of 10%.

Moreover, the categorization as the three levels, that is, excellent, good, and poor levels, as described above, is exemplary. Therefore, the present disclosure is not limited to the three levels. The categorization as various predetermined number of levels, instead of the three levels, is possible. To the present end, in addition to the first setting time and the second setting time, it is possible that a setting time is determined for use.

According to an exemplary embodiment of the present disclosure, as described above, when battery charging performance information and the battery state information are separately provided to indicate one of the three levels: excellent, good, and poor, the battery charging performance information and the battery state information that are provided may be very useful to the driver.

FIG. 2 is a diagram illustrating an example of the battery state information displayed by the controller on a display device of the vehicle before and during the vehicle traveling according to an exemplary embodiment of the present disclosure. The excellent, good, and poor levels, as described above, may be predefined such that it is distinguished by color. Thus, it is possible that a current state is indicated by displaying a predetermined figure, such as an asterisk, in a superimposed manner on a portion identified by color corresponding to the current state, so that the driver can intuitively recognize current battery charging performance.

In examples in FIG. 1 and FIG. 2, charging performance of the vehicle means a charging time at a reference battery SOC value of 10 to 80%. This charging time means the time taken to charge the battery at the current battery temperature to accomplish a change from the SOC value of 10% to the SOC battery of 80%. From the graph in FIG. 1, it may be seen that the charging time corresponding to the current battery temperature may be determined. The charging time obtained from the graph in FIG. 1 is the charging time taken for the battery to change from the battery SOC value of 10% to the battery SOC value of 80%, but not the charging time taken for the battery to change from a value of a current actual battery SOC to the battery SOC value of 80%.

Furthermore, when displaying a current state of the battery associated with the charging performance, the controller is configured to determine the charging time from the current battery temperature measured by the sensor with reference to the graph in FIG. 1 and then displays the determined charging time, as the battery state information associated with the charging performance, on the display device, as illustrated in FIG. 2. Accordingly, the driver can determine current battery charging performance from current state information indicated by the asterisk and from the charging time information.

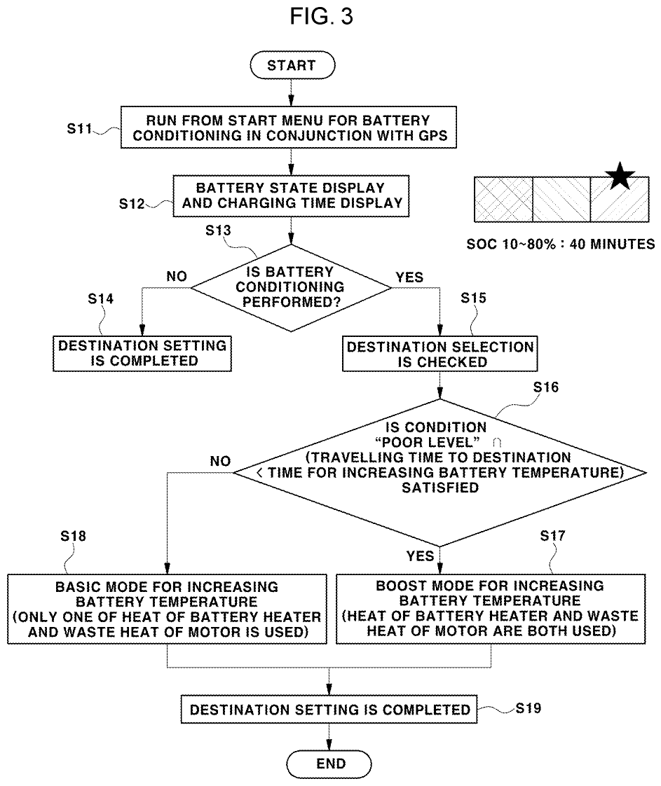

FIG. 3 is a flowchart illustrating a battery conditioning process according to the exemplary embodiment of the present disclosure, and illustrates a method of increasing a battery temperature and controlling the temperature thereof, the method being configured for being performed while the vehicle travels. According to an exemplary embodiment of the present disclosure, battery conditioning may mean battery temperature control.

According to an exemplary embodiment of the present disclosure, the controller in charge of control for the battery conditioning is provided to be connected to a navigation device and to exchange information with the navigation device. As known, the navigation device is configured so that the driver inputs his or her destination thereinto. When the driver inputs the destination, the navigation device is set to search for an optimal path from a current location to the destination.

The navigation device includes an input unit, a display unit, and a Global Positioning System (GPS) receiver. According to an exemplary embodiment of the present disclosure, the navigation device provides to the controller destination information being input by the driver and information on the traveling time to the destination which is the time taken for the vehicle to travel to the destination, in addition to vehicle location information obtained through the GPS receiver.

The battery conditioning process according to an exemplary embodiment of the present disclosure is described in more detail with reference to FIG. 3. When the driver inputs the destination into the navigation device and the path for traveling to the destination is found as a result of the search, a process for conditioning the battery in conjunction with the GPS starts (S11). The destination here may be a place where the battery may be charged. For example, the destination may be the charging station where the battery of the electric vehicle may be fast charged.

When the process for conditioning the battery starts, the controller may be configured to determine the charting time corresponding to the battery temperature from the current battery temperature measured by the sensor, using charging time setting information illustrated in FIG. 1. Furthermore, the current battery state associated with the battery charging performance may be determined, as one of the three levels, that is, excellent, good, and poor levels, from the determined charging time, using the charging performance setting information as in FIG. 1.

Subsequently, the controller is configured to provide the battery state information and the charging time that are determined, as displayed on the display device of the vehicle in the form of a bar illustrated in FIG. 2 (S12). The providing of the present information may assist the driver in determining whether or not the battery conditioning is performed.

Subsequently, the controller is configured to display on the display device guidance information indicating that whether or not the battery conditioning is performed needs to be selected and that the result of the selection needs to be input. Accordingly, the driver determines whether or not the battery conditioning is performed, and then inputs the result of the determination into an input device connected to the controller.

At the present point, when the driver does not make a selection to perform the battery conditioning, the controller ends the battery conditioning process. Furthermore, in the navigation device, a currently set destination is maintained, and destination setting is completed (S13 and S14).

In contrast, when the driver makes a selection to perform the battery conditioning, in a state where the driver selects the destination (S15), the controller is configured to determine a mode for increasing the battery temperature based on current battery state information associated with the battery charging performance and of information on the time taken for the vehicle to travel from a current location to the destination (hereinafter referred to as “traveling time to the destination) (S16).

At the present point, when a condition that the current battery state is at the poor level and a condition that the result of comparing the traveling time to the destination and a time for increasing the battery temperature is that the traveling time to the destination is shorter than the time for increasing the battery temperature is both satisfied, the controller is configured to select the boot mode for increasing the battery temperature (S17). When none of the two conditions are satisfied, the controller is configured to select a basic mode for increasing the battery temperature (S18).

The time for increasing the battery temperature may be defined as the time taken for the battery at the current battery temperature to reach the excellent level when the current battery state is not at the excellent level and may be the time which is preset to be in the controller.

Furthermore, the boost mode for increasing the battery temperature is a mode that can increase the battery temperature faster than the basic mode for increasing the battery temperature. When the current battery state is at the poor level and where the traveling time to the destination is shorter than the time for increasing the battery temperature, and thus where there is no time to reach the destination at a destination-arrival point in time, a boost mode for increasing the battery temperature is selected. In the boost mode, a battery heater and a waste heat of a motor are utilized to rapidly increase the battery temperature as described above. The battery heater here is a heater which is supplied with electric power of the battery and operates to generate heat.

In contrast, the basic mode for increasing the battery temperature is a mode for increasing the battery temperature, in which only the battery heater which is relatively precisely controllable may be used. The basic mode for increasing the battery temperature is a mode which is selected when the current battery state is not at the poor level or where the traveling time to the destination is equal to or longer than the time for increasing the battery temperature, and thus where there is time to reach the destination at a destination-arrival point in time. In the basic mode for increasing the battery temperature, only the waste heat of a power electronic (PE) component may be used instead of the battery heater. At the present point, one or a plurality of power electronic (PE) components may be selected among a motor, an inverter, a charging apparatus, and a converter.

When the driver makes a selection to perform the battery conditioning in the present manner, the controller may select only of the two modes for increasing the battery temperature considering the battery state information associated with the charging performance and the suitability of the time for increasing the battery temperature to the traveling time to the destination and then may perform control for increasing the battery temperature according to the selected mode for increasing the battery temperature.

In the boost mode for increasing the battery temperature and the basic mode for increasing the battery temperature, methods of increasing the battery temperature is all coolant-heated type methods of increasing the battery temperature using a coolant circulating along a duct among the power electronic (PE) component (for example, the motor), the battery, and the battery heater. In the instant case, the coolant may be selectively allowed to pass through the power electronic (PE) component, for example, the motor, through a bypass passage and a bypass valve.

However, unlike in the basic mode for increasing the battery temperature in which only one of waste heat generated in the motor and heat of the battery heater is transferred to the battery through the coolant, in the boost mode for increasing the battery temperature, the battery heater is turned on, and thus the coolant is heated by the waste heat of the motor, as well as the heat of the battery heater. Consequently, the coolant heated by the heat of the motor and the heat of the battery heater increases the battery temperature. At the present point, the heated coolant increases the temperature of the battery while passing through a coolant passage within the battery.

As described above, the controller is configured to perform control according to the selected mode for increasing the battery temperature and thus increases the battery temperature until the battery temperature reaches the excellent level. After the controller is configured to start to perform control for the selected mode for increasing the battery temperature, setting of the destination is completed (S19).

Accordingly, in the vehicle, the boost mode for increasing the battery temperature and the basic mode for increasing the battery temperature is automatically selected according to the current battery state with respect to the charging performance and the destination being input by the driver. Thus, when the vehicles arrive at the destination, the charging performance and the battery state that are at the excellent level may be secured. Furthermore, the mode for increasing the battery temperature is separately performed, and thus the efficiency of energy management may be increased.

FIG. 3 illustrates only the process for increasing the battery temperature. However, when the current battery state is at the poor level with respect to the charging performance and cooling of the battery is necessary to enter the excellent level, the controller can cool the battery by operating a battery cooling system and thus can decrease the battery temperature.

The battery cooling system may include a battery chiller that cools the coolant. The battery chiller is a type of heat exchanger which is configured to cause heat exchange between a refrigerant of an air-conditioning system and the coolant. The battery cooler is provided on a path along which the coolant circulates. Furthermore, the battery cooling system is configured so that the refrigerant distributed through a separate pipe from the air-conditioning system passes through an expansion valve and so that the low-temperature low-pressure refrigerant that passes through the expansion valve passes through the battery chiller and then returns to the air-conditioning system.

Accordingly, in the battery chiller, the heat exchange takes place between the low-temperature refrigerant and the coolant. Subsequently, the coolant cooled by the refrigerant cools the battery while passing through the coolant passage within the battery. Of course, the circulation of the refrigerant in the air-conditioning system and the battery cooling system takes place by driving a compressor with electric power of the battery.

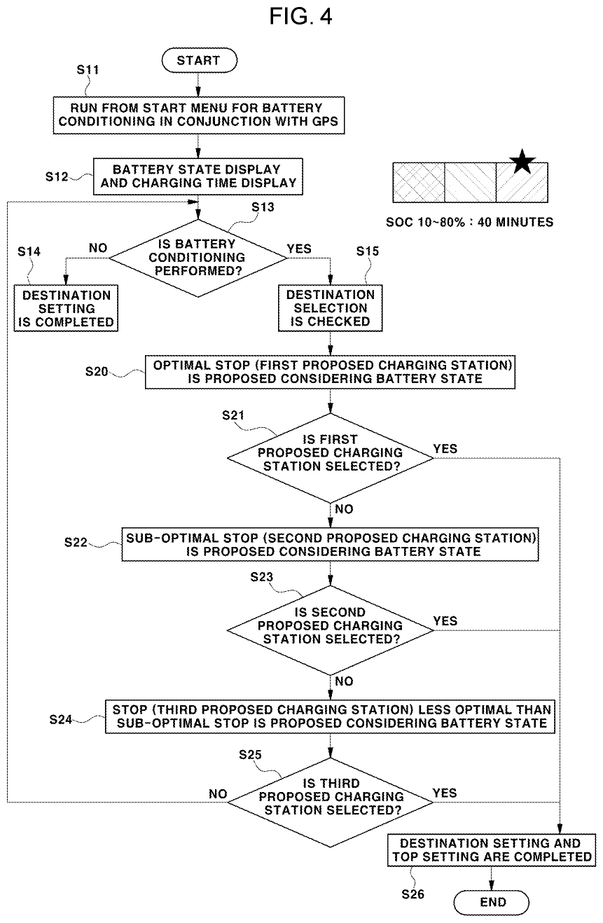

FIG. 4 is a flowchart illustrating a process of proposing the charging station, as a stop, in the method of conditioning a battery according to the exemplary embodiment of the present disclosure. As described with reference to FIG. 3, when the driver inputs the destination into the navigation device and the path for traveling to the destination is found as a result of the search, the process for conditioning the battery in conjunction with the GPS starts (S11).

When the process for the battery conditioning starts, the controller may be configured to determine the charging time corresponding to the battery temperature from the current battery temperature measured by the sensor using the charging time setting information illustrated in FIG. 1. Furthermore, the current battery state associated with the battery charging performance may be determined, as one of the three levels, that is, excellent, good, and poor levels, from the determined charging time, using the charging performance setting information as in FIG. 1.

Subsequently, the controller is configured to provide the battery state information and the charging time that are determined, as displayed on the display device of the vehicle in a form of a bar illustrated in FIG. 2 (S12). The providing of the present information may assist the driver in determining whether or not the battery conditioning is performed.

Subsequently, the driver determines whether or not the battery conditioning is performed and inputs the result of the determination into the input device connected to the controller. At the instant time, when the driver does not make a selection to perform the battery conditioning, the controller ends the battery conditioning process. Furthermore, in the navigation device, the currently set destination is maintained, and the destination setting is completed (S13 and S14).

In contrast, when the driver makes a selection to perform the battery conditioning, in a state where the driver selects the destination (S15), the controller is configured to provide a first proposed charging station as a stop on the path for traveling to the destination, considering the current battery state information with respect to the battery charging performance and the path for traveling to the destination (S20). Regarding the providing of the charging station, the first proposed charging station may be provided on a map displayed on the display unit of the navigation device.

At the present time, the battery conditioning that causes the battery heater or the battery cooling system to operate is performed considering the time taken to accomplish a change from the current battery temperature to the battery temperature at the excellent level at which the charging performance is optimal. Furthermore, when the battery state can switch to the excellent level within the time taken for the vehicle on the path for traveling to arrive at a fast-charging station positioned closest to a current location, such a fast-charging station may be proposed as an optimal stop.

Furthermore, the controller is configured to provide guidance information to the driver to input the result of determining whether or not the first proposed charging station is selected as a stop. At the instant time, for guidance, necessary information is displayed on the display device. Accordingly, when the driver wants to use the first proposed charging station, he/she performs an input operation of selecting the first proposed charging station as a stop through the use of the input device.

The input device may be the input unit of the navigation device. For example, the input device may be a touch screen-type input unit of the navigation device, into which the display unit and the input unit are integrated. The navigation device and the controller are connected to exchange information with each other.

Subsequently, the controller is configured to check whether or not the first proposed charging station is selected as a stop (S21). When it is determined that the driver selects the first proposed charging station as the stop, the first proposed charging station is finally set as the stop in the navigation device. Moreover, because the driver already previously inputs the destination, setting of the path for traveling, including the stop and the destination, is all completed (S26).

However, when the driver does not select the first proposed charging station as the stop, to improve the charging performance, a sub-optimal charging station, that is, a second proposed charging station may be determined as the charging station and thus proposed as the sop (S22). Furthermore, the controller is configured to check whether or not the second proposed charging station is selected as the stop (S23). When the driver does not select the second proposed charging station as the stop, in the same manner, a charging station which is less optimal than the sub-optimal charging station, that is, a third proposed charging station, may be determined and proposed as the stop (S24).

At the present point, the controller may switch to the battery state to the excellent level within the time taken for the vehicle to arrive at the destination while on the path for traveling, and may determine the fast-charging station positioned the second closest to the current location as the second proposed charging station. Likewise, the controller may be configured to determine the fast-charging station positioned the third closest to the current location as a third proposed charging station.

Furthermore, the controller is configured to check whether or not the third proposed charging station is selected as the stop (S25). When the driver selects the second proposed charging station or the third proposed charging station as the stop, the second proposed or third proposed charging station is finally set as the stop in the navigation device. Because the driver already previously inputs the destination, the setting of the path for traveling, including the stop and the destination, is all completed (S26).

In the present manner, with the method of conditioning a battery according to an exemplary embodiment of the present disclosure, while traveling to the destination or the charging station, the electric vehicle operates the battery heater or the battery cooling system using electrical energy stored in the battery. Thus, before charging, the battery temperature may be controlled to reach the optimal temperature. Moreover, the vehicle is provided with the battery state information with respect to the charging performance. Thus, the driver may be encouraged to experience a learning effect and to secure the charging performance before fast charging.

Furthermore, in the vehicle, a boost mode for increasing battery temperature or a basic mode for increasing the battery temperature is automatically selected and performed considering a battery state and a path for traveling before traveling. Thus, the vehicle can secure the battery state which is at the excellent level in terms of charging performance when arriving at the destination. One of the boost mode for increasing the battery temperature and the basic mode for increasing the battery temperature is selected considering the current battery state, the destination, a current vehicle location, and the like when increasing the battery temperature. Thus, the efficiency of energy management may be increased.

Furthermore, when the destination is set in the navigation device, the vehicle automatically guides the driver in traveling to the optimal fast-charging station which is determined considering the battery state and the path for traveling, as the stop. Thus, the efficient battery charging performance may be secured.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by multiple control devices, or an integrated single control device.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A method of conditioning a battery of an electric vehicle, the method comprising:
obtaining, through testing, information on charging time of the battery varying with a temperature thereof, and providing, to a controller, charging performance setting information as set by categorizing battery charging performance into a plurality of levels based on the obtained information on charging time;
determining, by the controller, a charging time corresponding to a current battery temperature measured through a sensor, from the measured current battery temperature using the information on the charging time varying with the battery temperature;
selecting, by the controller, a level indicating current battery charging performance, among the plurality of levels, from the determined charging time corresponding to the current battery temperature using the charging performance setting information; and
displaying, by the controller, the selected level on a display device of the vehicle in an identifiable manner.

2. The method of claim 1, wherein in the charging performance setting information, the plurality of levels include first, second, and third levels that result from the categorizing based on the information on the charging time varying with the battery temperature.

3. The method of claim 2,
wherein in the selecting of the level indicating the current battery charging performance, when the charging time corresponding to the determined current battery temperature is shorter than a first preset setting time, the first level is selected,
wherein when the charging time corresponding to the determined current battery temperature is equal to or longer than the preset first setting time and is shorter than a second preset setting time, the second level is selected, and
wherein when the charging time corresponding to the determined current battery temperature is equal to or longer than the preset second setting time, the third level is selected.

4. The method of claim 1,
wherein the plurality of levels indicating the battery charging performance are identified in different colors, respectively, in a distinguished manner, and
wherein in the displaying of the selected level on the display device in the identifiable manner, a predetermined figure indicating the current battery charging performance is displayed, in a superimposed manner, on a portion of information displayed on the display device which is identified by color corresponding to the selected level.

5. The method of claim 1, wherein in the information on the charging time varying with the battery temperature, the charging time is a time taken to charge the battery at each battery temperature from a first state of charge (SOC) to a second SOC as preset.

6. The method of claim 5, wherein in the displaying of the selected level on the display device in the identifiable manner, the information displayed on the display device includes a time taken to charge the battery at the current battery temperature from the first SOC to the second SOC.

7. The method of claim 1, further including:
providing, by a navigation device, to the controller, destination information and information on a path for traveling to a destination, which are received from a driver, and information on a traveling time to the destination which is taken for the vehicle to travel from a current location to the destination, before the vehicle travels; and
performing, by the controller, battery conditioning for controlling battery temperature based on the destination information and the information on the traveling time to the destination that are provided, while the vehicle travels.

8. The method of claim 7, further including:
displaying, by the controller, on the display device guidance information indicating that whether or not the battery conditioning is performed needs to be selected and that a result of the selection needs to be input, after the displaying of the selected level in the identifiable manner,
wherein the battery conditioning is performed in a case where, through an input device connected to the controller, a selection is made to perform the battery conditioning and where a result of the selection is input.

9. The method of claim 7, wherein in the charging performance setting information, the plurality of levels include first, second, and third levels that result from the categorizing by the information on the charging time varying with the battery temperature,
wherein in the selecting of the level indicating the current battery charging performance, when the charging time corresponding to the determined current battery temperature is shorter than a preset first setting time, the first level is selected,
wherein when the charging time corresponding to the determined current battery temperature is equal to or longer than the preset first setting time and is shorter than a preset second setting time, the second level is selected, and
wherein when the charging time corresponding to the determined current battery temperature is equal to or longer than the preset second setting time, the third level is selected.

10. The method of claim 9, wherein in the performing of the battery conditioning, modes for increasing a battery temperature, which are differentiated according to a level indicating the selected current battery charging performance and to the information on the traveling time to the destination are performed.

11. The method of claim 7, wherein in the charging performance setting information, the plurality of levels include first, second, and third levels that result from the categorizing by the information on the charging time varying with the battery temperature, and
wherein in the performing of the battery conditioning, when a condition that the level indicating the selected current battery charging performance is the third level and a condition that the traveling time to the destination is shorter than a preset time for increasing the battery temperature are satisfied, among the modes for increasing the battery temperature, a boost mode for increasing the battery temperature in which waste heat of a power electronic component and heat of a battery heater are used at a same time to increase the battery temperature is performed.

12. The method of claim 7, wherein in the charging performance setting information, the plurality of levels include first, second, and third levels that result from the categorizing by the information on the charging time varying with the battery temperature, and
wherein in the performing of the battery conditioning, when even one of a condition that a level indicating the selected current battery charging performance is the third level and a condition that the traveling time to the destination is shorter than a preset time for increasing the battery temperature is not satisfied, among the modes for increasing the battery temperature, a basic mode for increasing the battery temperature in which only predetermined one of waste heat of power electronic component and heat of a battery heater is used to increase the battery temperature is performed.

13. The method of claim 8, further including:
determining, by the controller, a charging station present on the path for traveling, as a stop, based on the destination information and the information on the path for traveling to the destination that are provided and displaying, by the controller, the determined charging station on the navigation device, when through the input device, a selection is made to perform the battery conditioning and where a result of the selection is input.

14. The method of claim 13, wherein in the charging performance setting information, the plurality of levels include first, second, and third levels that result from the categorizing by the information on the charging time varying with the battery temperature, and
wherein when determining the charging station as the stop, if the level indicating the battery charging performance is able to switch to the first level within a time taken for the vehicle on the path for traveling to arrive at a charging station positioned closest to a current location of the vehicle, the controller is configured to determine the charging station as the stop.

15. The method of claim 14, wherein the controller is configured to cause the navigation device to display guidance information so that the driver is able to select the charging station determined as the stop,
wherein when the driver does not select the displayed stop, when the level indicating the battery charging performance is able to switch to the first level within the time taken for the vehicle on the path for traveling to arrive at a sub-optimal charging station positioned the second closest to a current location, the controller is configured to determine such a sub-optimal charging station as the stop, and
wherein the controller is configured to cause the navigation device to display guidance information so that the driver is able to select the determined sub-optimal charging station.
